(19) United States
(12) Patent Application Publication
(10) Pub. No.: US 2018/0087303 A1
(43) Pub. Date: Mar. 29, 2018

(54) COVERING DEVICE FOR A TOOL STORAGE STATION

(71) Applicant: Stäubli Tec-Systems GmbH, Bayreuth (DE)

(72) Inventors: Wolfgang Kohler, Pegnitz (DE); Markus Schindler, Speichersdorf (DE)

(21) Appl. No.: 15/577,210

(22) PCT Filed: May 26, 2016
(86) PCT No.: PCT/EP2016/061899

§ 371 Date: Nov. 27, 2017

(30) Foreign Application Priority Data
May 28, 2015 (EP) 15169753.9

(51) Int. Cl. E05D 15/10; E05F 15/50; E05D 15/32; E06B 5/00

(52) U.S. Cl. CPC E05D 15/1005; E05F 15/50; E05Y 2900/602; E06B 5/00; E05D 15/32

(57) ABSTRACT

The invention relates to a covering device for a tool deposition station. The covering device includes a covering as well as a mechanism for moving the covering. The mechanism for moving the covering includes a rail and a first driver which is guided by the rail. The first driver is displaceable along the rail and is connected to the covering. The covering device can be brought into an opened position by way of a displacing of the first driver along the rail in a first direction and the covering device can be brought into a covered position by way of a displacing the first driver along the rail in a second direction which is opposite to the first direction. The mechanism is configured such that the displacing of the first driver effects at least a partial translatory movement of the covering.

### CROSS-REFERENCE TO RELATED APPLICATION

The present application is a national phase application of PCT application PCT/EP2016/061899, internationally filed on May 26, 2016, pursuant to 35 U.S.C. § 371, which claims priority to European Application 15 16 9 753.9, filed May 28, 2015. Both applications are incorporated herein by reference in their entirety.

### TECHNICAL FIELD

The invention relates to a covering device for a tool deposition station, according to the preamble of claim 1. The invention moreover relates to a tool deposition station.

### BACKGROUND

Industrial robots for industrial manufacturing and machining processes can often be provided with different tools. These tools are kept in tool deposition stations when they are not used, from which stations they can be automatically removed when required and into which they can be subsequently automatically deposited, by the industrial robot. Covering devices of tool deposition stations for industrial robots are known from the state of the art. These covering devices serve e.g. for protecting tool-side openings from the ingress of contamination. Known covering devices include a covering which is pivotably connected to the tool deposition station, wherein the bringing of the covering device from a covered into an opened position or vice versa typically includes a pivoting movement of the covering about a relative large angle between 120° and 130°. Although such a covering device ensures a reliable protection from the ingress of dirt, an opening and closing however typically entails relatively long cycle times.

### SUMMARY

Embodiments of the invention can provide a covering device for a tool deposition station, said covering device overcoming the disadvantages mentioned above. In some embodiments, the covering device can be brought efficiently and quickly from the closed position into the opened position and vice versa.

In some embodiments, the covering device includes a covering as well as a mechanism for moving the covering. The mechanism for moving the covering includes a rail and a first driver which is guided by the rail, is displaceable with respect to the rail and is connected to the covering, wherein the covering device can be brought into an opened position by way of a displacing of the first driver along the rail in a first direction, and wherein the covering device can be brought into a covered position by way of a displacing of the first driver along the rail in a second direction which is opposite to the first direction. The mechanism for moving the covering is designed in a manner such that the displacing of the first driver along the rail effects at least a partial translatory movement of the covering.

On account of the covering device according to the invention, one succeeds in the covering not executing a purely pivoting movement. On the one hand, the at least partial translatory movement of the covering is advantageous since a quicker opening and closing of the covering device can be achieved by way of this, which permits a rapid tool change of the industrial robot particularly regarding tool deposition stations for industrial robots. On the other hand, the at least partial translatory movement of the covering entails the advantage of the openings and closing assuming less space above the covering, which likewise permits a more rapid tool change, since a tool receiving device of the industrial robot can therefore be led closely up to the tool deposit before or during the opening of the covering device.

In some embodiments, the first driver can include a recess which due to its shape is suitable for encompassing the rail. The rail can be formed in a horizontal direction, by which means the first driver is displaceable in the horizontal direction. The rail can be designed in a manner such that the first driver runs through a straight path or an arcuate path on displacing.

In some embodiments, the covering device can include a first guide element which is rigidly connected to the covering, wherein the covering is rotatably connected to the first driver about a rotation axis which is distanced to the first guide element and wherein the mechanism for moving the covering includes a second guide element in engagement with the first guide element, wherein the first and the second guide element are designed and arranged in a manner such that the displacing of the first driver effects a rotation movement of the covering about the rotation axis, additionally to the at least partial translatory movement of the covering. In some embodiments, the second guide element is typically immovably arranged relative to the rail and the movement of the first guide element which is rigidly connected to the covering is guided by the second guide element.

In some embodiments, the second guide element can be designed as a groove. A groove is suitable e.g. for a guidance of the first guide element from two opposite sides, by which means a secure guidance can be achieved, particularly with a rapid opening and closing procedure of the covering device. In some embodiments, the first guide element can be designed as a lug. If the second guide element is designed as a groove, then this lug can be received in the groove or project into the groove in a manner such that the lug is guided by the groove on opening and closing the covering device.

In some other embodiments, the first guide element, which is rigidly connected to the covering, can be designed as a groove and the second guide element, which is immovably arranged relative to the rail, can be designed as a lug. In both cases, the movement of the covering on opening and closing the covering device is defined by the shape of the groove.

A further embodiment envisages the first guide element being designed as a roller. A roller is suitable for rolling on a surface of the second guide element. A mechanical wearing of the first and second guide element can be minimised by way of this.

In some embodiments, the rotation movement can be effected e.g. by way of the second guide element guiding the first one or the first guide element guiding the second one, such that the rotation axis which is movable along the rail and the first guide element which is rigidly connected to the covering, at least in sections run through differently long path stretches during and opening or closing procedure of the covering device.

For example, in some embodiments, the first driver can be displaceable relative to the rail in a manner such that on opening and closing, the rotation axis which is fixedly arranged relative to the first driver executes a straight-lined translation movement which is guided by the rail. In some embodiments, the first and the second guide element can then be designed in a manner such that the first guide element which is distanced to the rotation axis and is rigidly arranged on the covering is guided by the second guide element on a path which is arcuate at least in sections, on displacing the first driver along the rail. Alternatively, in some other embodiments, the first and the second guide element can also be designed in a manner such that on displacing the first driver along the rail, the first guide element is guided on a straight-lined path by the second guide element, but with the rail encloses an angle which is different to 180°.

In some embodiments, the covering can be designed in a plate-like manner. The rotation axis can then be aligned parallel to a plane which is defined by the plate-like covering. The rotation axis can be orientated in a horizontal direction and herein perpendicularly to the first and second direction.

In some embodiments, the covering can firstly execute a combination of a rotation and translation movement during an opening procedure of the covering device and subsequently execute a purely translatory movement. On the one hand, such a sequence can permit a secure covering of tools in the covered position of the covering device and on the other hand permit a rapid opening of the covering device.

In some embodiments, the rail includes a cavity which extends along a longitudinal direction of the rail, and a second driver which guided in this cavity and is displaceable along the longitudinal direction of the rail, wherein the first driver and the second driver are coupled in a manner such that the displacing of the second driver effects the displacing of the first driver. An opening and closing of the covering device can therefore achieved by way of the second driver being driven.

In some embodiments, the rail includes at least one compressed air connection for subjecting the cavity to an overpressure or to a vacuum, wherein design of the cavity and the second driver and the guidance of the second driver in the cavity are such that a subjecting of the cavity to an overpressure or to a vacuum via the compressed air connection effects a displacing of the second driver within the cavity and specifically along the rail.

For example, in some embodiments, a compressed air connection can be provided at two opposite ends of the rail. An application of an overpressure or a vacuum to one of the compressed air connections then leads to the displacing of the second driver, which, given a coupling the movements of the first and the second driver, can result in a displacing of the first driver. The opening or closing of the covering device is therefore driven by way of compressed air.

In some embodiments, the first driver and the second driver can be designed in a manner such that the first driver and the second driver are coupled or can be coupled via a magnetic force, i.e., the first and/or the second driver can include a permanent magnet, or a permanent magnet can be fixedly arranged on the first and/or the second driver. Alternatively or additionally, in some embodiments, the first and/or the second driver can include an electromagnet or an electromagnet can be fixedly arranged on the first and/or on the second driver.

It is by way of such a magnetic attraction that one succeeds in the displacing of a first driver resulting in the displacing of the second driver if the distance between the first and the second driver along the first direction is sufficiently small. The movements of the first and the second driver can be decoupled if the distance between the first and the second driver along the first direction is sufficiently large.

In some embodiments, if the movements of the first and second driver are coupled, then a magnetic attraction between the first and the second driver can have an attraction force of at least 10 N and/or at the most 200 N. In some embodiments, if the movements of the first and second driver are coupled, then a magnetic attraction between the first and the second driver can have an attraction force of at least 60 N and/or at the most 80 N.

In some embodiments, the movements of the first and the second driver can also be decoupled by a force action upon the first driver or upon the covering. If the covering hits an obstacle for example during the opening or the closure of the covering device, so that the displacing of the first driver is blocked, the second driver can be moved further in the cavity of the rail, whilst the first driver rests on the rail. Damage to the covering device which arises due to a collision between the covering and the obstacle can thus be limited. Possible damage to the obstacle can also be limited in this way. The movements of the first and the second driver can be brought again into a coupled condition by way of the first and second driver approaching one another again after removal of the obstacle.

In some embodiments, the rail is designed in the shape of a tube with a round cross section and the second driver is designed in the shape of a cylinder. In such embodiments, an outer diameter of the second driver can be smaller than an inner diameter of the rail. In some embodiments, the outer diameter of the second driver can be only slightly smaller than an inner diameter of the rail.

In some embodiments, the covering device can include at least one sensor which is configured to detect at least one position of the first driver relative to the rail.

A detecting of the position of the first driver can permit, for example, an automated recognition as to whether the covering device is located in the opened position or in the covered position. In some embodiments, the at least one sensor can be configured for example to detect a magnetic scatter field which is caused by a magnetic material of the first driver. In some embodiments, the covering device can moreover include at least one second sensor which is configured to detect at least one position of the second driver.

In some embodiments, the invention can relates to a tool deposition station with at least one receiver for receiving a tool and with at least one covering device as described above. In some embodiments the invention can relates to a tool deposition station with at least one receiver for receiving a tool by an industrial robot.

In some embodiments, the mechanism can include a first connecting piece and a second connecting piece. In such embodiments, the first connecting piece can be rotatably connected to the first driver about a second rotation axis and rotatably connected to the covering about a third rotation axis. Furthermore, the second connecting piece can be rotatably connected to the first driver about a fourth rotation axis and rotatably connected to the covering about a fifth rotation axis. The first connecting piece can include a third guide element which is distanced to the second rotation axis and the mechanism can include a fourth guide element in engagement with the third guide element. In such embodiments, the mechanism can be designed in a manner such that the displacing of the first driver effects an essentially purely translatory and non-linear movement of the covering. In some embodiments, the second rotation axis, the third rotation axis, the fourth rotation axis, the fifth rotation axis, the third guide element and the fifth guide element are arranged and aligned to one another such that the displacing of the first driver effects the essentially purely translatory and non-linear movement of the covering. In some embodiments, the second, third, fourth and fifth rotation axis are orientated parallel or essentially parallel to one another.

A particularly space-saving embodiment can be achieved by way of this. In some embodiments, the displacement of the first driver effects a movement, with regard to which the covering comes to lie lower in the covered position of the covering device than in the opened position, on designated application of the covering device. One therefore succeeds in the covering reliably covering a tool which is arranged in the receiver, when the covering device is in the covered position. If the covering device is brought into the opened position, the covering is hereby typically firstly lifted. The covering is then typically moved in a purely translatory manner subsequent to this, i.e. in the further course of an opening procedure.

In some embodiments, the third guide element can be designed for example as a roller. The fourth guide element can be designed for example as a groove, in which the roller can roll.

In some embodiments, the first driver is typically linearly displaceable. In some embodiments, a fifth guide element which is rigidly connected to the first driver and a sixth guide element in engagement with the fifth guide element can be provided. In some embodiments, the fifth guide element can be linearly guidable by the sixth guide element given a movement of the first driver. Given a linear displacing of the first driver on the rail, an additional guidance of the first driver, in particular a guidance perpendicular to a radial and to an axial direction of the rail can be achieved by way of this.

### BRIEF DESCRIPTION OF THE FIGURES

An embodiment example of the invention is hereinafter described by way of figures.

FIG. 1 shows a lateral view of the covering device in an opened position.

FIG. 2 shows a perspective view of the covering device in the opened position which is shown in FIG. 1.

FIG. 3 shows a lateral view of the covering device which is shown in FIGS. 1 and 2, here in a partly opened position.

FIG. 4 shows a perspective view of the covering device in the partly opened position which is shown in FIG. 3.

FIG. 5 shows a lateral view of the covering device which is shown in FIGS. 1 to 4, here in a covered position.

FIG. 6 shows a perspective view of the covering device in the covered position which is shown in FIG. 5.

FIG. 7 shows a lateral view of a second guide element of the covering device which is shown in FIGS. 1 to 6.

FIG. 8 shows an exploded drawing of a rail, of a first and of a second driver, of the covering device which is shown in FIGS. 1 to 6.

FIG. 9 shows a perspective view of a holder of the covering device which is shown in FIGS. 1 to 8.

FIG. 10 shows a lateral view of the covering device which is shown in FIGS. 1 to 9, and an obstacle.

FIG. 11 shows a perspective view of parts of a mechanism for moving the covering.

FIGS. 12(a), 12(b), and 12(c) show lateral views of a covering device at various points in time during the opening of the covering device.

### DETAILED DESCRIPTION

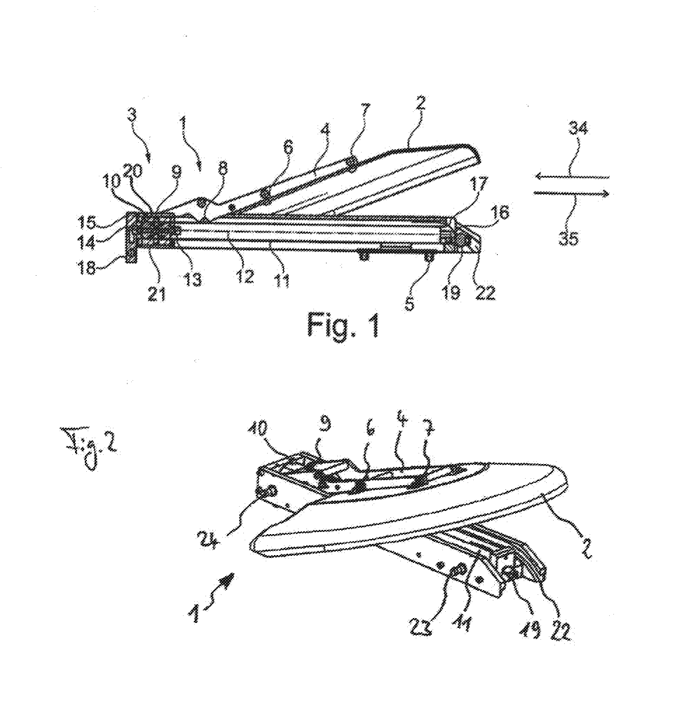

A covering device 1 for a tool deposition station is shown in a lateral view in FIG. 1. The covering device 1 includes a covering 2, a mechanism 3 for moving the covering 2, as well as fastening means 5 for fastening the covering device 1 to a tool deposition station.

The mechanism 3 includes a holder 4, on which the covering is fastened by way of screw connections 6, 7.

The mechanism 3 moreover includes a first driver 10. The holder 4 is rotatably connected to the first driver 10 about a horizontal rotation axis 9. The first driver 10 is guided on a rail 11 which is designed in the shape of tube with a round cross section and is manufactured of stainless steel. A longitudinal direction of the rail 11 here is orientated in the horizontal direction. The first driver 10 is displaceable along the longitudinal direction of the rail 11. A second driver 13 which is likewise displaceable in the horizontal direction is guided within a cavity 12 of the rail 11. The cavity 12 is arranged in the inside of the rail 11 and is encompassed by the rail 11. The cavity extends along the longitudinal direction of the rail 11.

A first stop 15 which limits a displacement of the first driver 10 and of the second driver 13 along the rail 11 in a first direction 34 is formed at a first end 14 of the rail 11. In the opened position of the covering device 1 which is shown in FIG. 1, the first driver 10 as well as the second driver 13 is in contact with the first stop 15, so that the first driver 10 and the second driver 13 are only displaceable along the rail 11 in a second direction 35 which is opposite to the first direction 34. Moreover, a second stop 17 is formed at a second end 16 of the rail 11. The second stop 17 limits the movement of the first driver 10 and of the second driver along the rail 11 in the second direction 35.

The cavity 12 can be subjected to overpressure and/or to a vacuum in the regions of the first end 14 of the rail 11 and of the second end 16 of the rail 11 via a first compressed air connection 18 and via a second compressed air connection 19. The compressed air connections 18, 19 are provided so that a displacing of the second driver 13 can be driven by way of compressed air. E.g. the second driver 13 is displaceable along the rail 11 in the first direction 34 by way of subjecting the cavity 12 to an overpressure via the second compressed air connection 19 within the cavity 12. Accordingly, the second driver 13 is displaceable along the rail 11 in the second direction 35 by way of subjecting the cavity 12 to an overpressure via the first compressed air connection 18 within the cavity 12.

The first driver 10 and the second driver 13 each include a permanent magnet 20, 21. The permanent magnets e.g. are integrated into the drivers 10, 13 or are fastened to the drivers 10, 13. The permanent magnets 20, 21 are designed in a manner such that a magnetic attraction between the first driver 10 and the second driver 13 couples the movements of the first driver 10 and of the second driver 13 so that a displacing of the second driver 13 in the cavity 12 results or can result in a displacing of the first driver 10 in the rail 11.

The mechanism 3 for moving the covering 2 includes a first guide element 8 in the form of two rollers which are fastened to the holder 4 and are rigidly connected to the covering 2 via the holder 4. The first guide element 8 is distanced to the rotation axis 9, on which the holder is rotatably connected to the first driver 10. The rollers 8 of the first guide element are aligned parallel to the rotation axis 9.

The mechanism 3 for moving the covering 2 moreover includes a second guide element 22 for guiding the first guide element 8. This second guide element 22 is formed by two grooves which are open towards the rail 11, in two components which are fixedly arranged laterally of the rail 11 and relative to the rail 11. One of the rollers of the first guide element 8 engages into one of the grooves of the second guide element 22, so that the first guide element 8 is guided by the second guide element 22 on displacing the first driver 10. The second guide element 22 which is fixedly arranged relative to the rail 11 guides the first guide element 8 which is rigidly connected to the covering 2, along a path which is defined by the shape of the grooves of the second guide element 2. Given alternative embodiments, the first guide element can also include at least one or several lugs which are rigidly connected to the holder 4 and which engage into the grooves of the second guide element 22 as the previously described rollers and are therefore guided in their movement by the grooves. These lugs are then also each distanced to the rotation axis 9 as the previously described rollers.

FIG. 2 shows a perspective view of the same covering device 1 in the opened position which is already represented in FIG. 1. Recurring features in this and in the following figures are provided with the same reference numerals. The covering device 1 additionally includes two sensors 23, 24 which are configured to detect a position of the first driver 10 relative to the rail 11 in the region of the first end 14 of the rail 11 and in the region of the second end 16 of the rail 11. The sensors 23, 24 can be designed e.g. as optical or magnetic sensors.

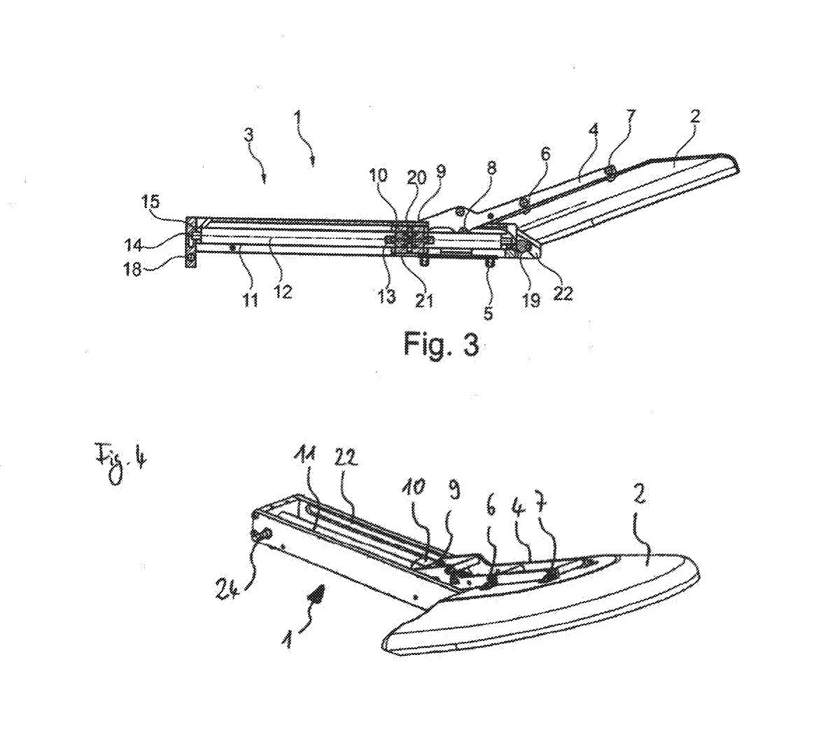

FIGS. 3 and 4 show a lateral view or a perspective view of the same covering device 1 in a partly opened position. The cavity 12 is subjected to compressed air via the compressed air connection 18, 19 so that the second driver 13 undergoes a movement to the right, thus in the second direction 35, for bringing the covering device 1 from the opened position which is represented in FIGS. 1 and 2 into the partly opened position which is represented in FIGS. 3 and 4. The first driver 10 then likewise undergoes a movement to the right, thus in the second direction 25 on account of the coupling of the movements of the first driver 10 and of the second driver 13 as a result of the magnetic attraction between the first driver 10 and the second driver 13.

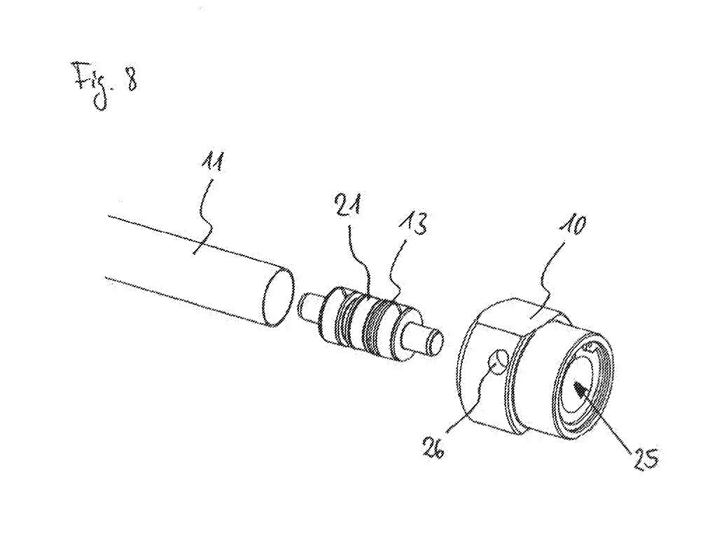

FIG. 7 shows a lateral view of the second guide element 22. The second guide element 22 has a first end 30 and a second end 32. A first section 31 of the second guide element 22 connects to the first end 30 of the second guide element 22, and a second section 33 of the second guide element 22 connects to the second end 32 of the second guide element 22.

The first section 31 of the second guide element 22 is aligned parallel to the rail 11 and thus parallel to the movement of the first driver 10 along the rail 11. As long as the first guide element 8 which is rigidly connected to the covering 2 is guided in the section 31 of the second guide element 22 which is aligned parallel to the rail 11, on movement of the first driver 10 along the rail 11, the rotation axis 9, via which the covering 2 is rotatably connected to the first driver 10 and the first guide element 8 which is distanced to the rotation axis 9 move parallel to one another, so that no rotation of the covering 2 with respect to the rotation axis 9 takes place in this section of the movement of the covering 2. The holder 4 and the covering 2 therefore undergo a purely translatory movement on bringing the covering device 1 from the opened position which is shown in FIGS. 1 and 2 into the partly opened position which is shown in FIGS. 3 and 4.

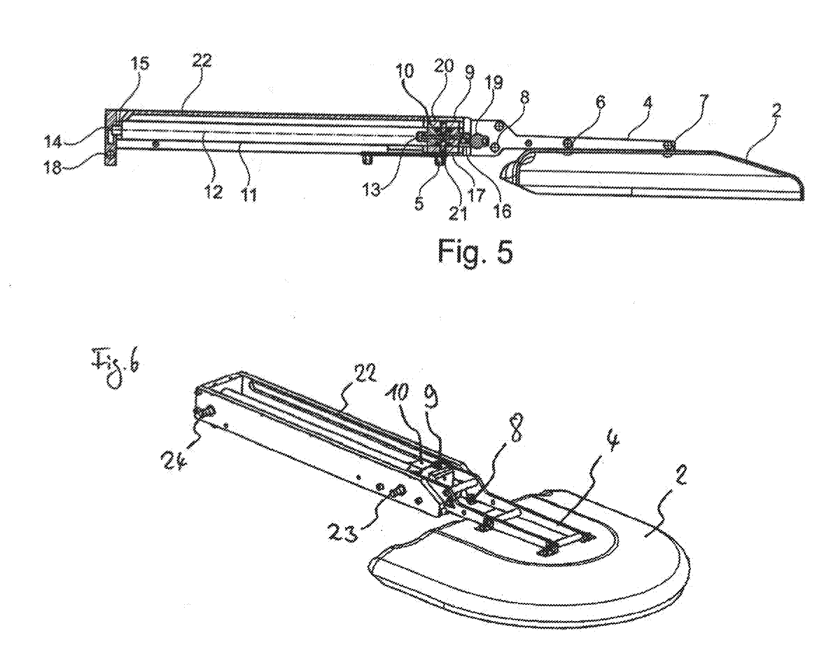

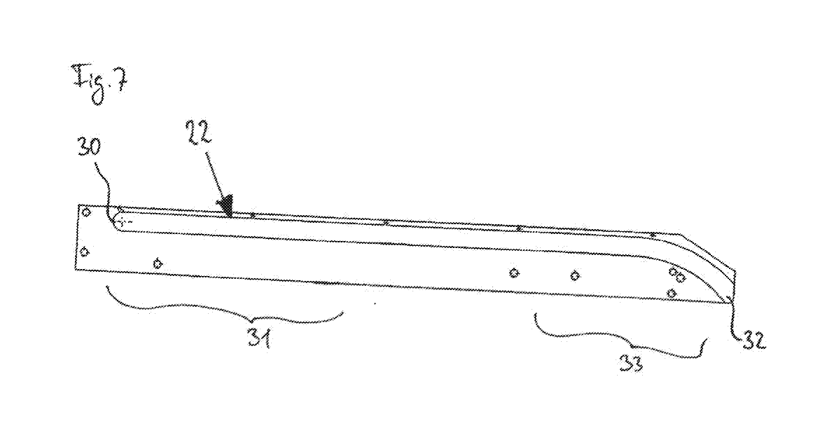

FIGS. 5 and 6 show a lateral view and a perspective view respectively, of the same covering device 1 in a covered position. The cavity 12 continues to be subjected to compressed air via the compressed air connections 18, 19 so that the second driver 13 and the first driver 10 undergo a movement along the rail 11 to the right, thus in the second direction 35, for bringing the covering device 1 from the partly opened position which is represented in FIGS. 3 and 4 into the covered position which is shown in FIGS. 5 and 6.

In the covered position of the covering device 1 which is shown in FIGS. 5 and 6, the first driver 10 as well as the second driver 13 are in contact with the second stop 17 which prevents a further movement of the first driver 10 and of the second driver 13 in the second direction beyond way of the second stop 17.

The second guide element 22 runs in an arcuate manner in the second section 33 of the second guide element 22 which is shown in FIG. 7. In this second section 33, the grooves of the second guide element 22 do not run parallel to the rail 11 as in the first section 31. Due to the fact that the grooves of the second guide element 22 run arcuately in the second section 32, the rollers of the first guide element 8 which engage into the grooves of the second guide element 22 are guided in the second section 32 of the second guide element 22 in a manner such that the rollers which are fixedly arranged relative to the covering 2 and the roller axis 9 which is distanced to the rollers and about which the covering 2 is rotatably connected to the first driver 10 run through a different path stretch on bringing the covering device 1 from the partly opened position which is shown in FIGS. 3 and 4 into the covered position which is shown in FIGS. 5 and 6. On account of this, the covering 2 undergoes a rotation movement with respect to the rotation axis 9, additionally to the translatory movement.

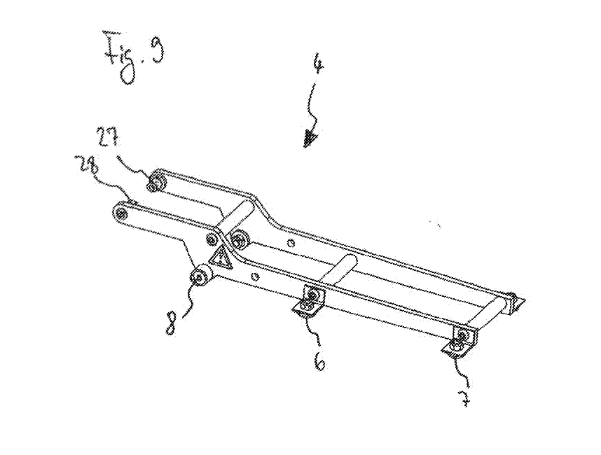

FIG. 8 shows an exploded drawing of the rail 11, of the first driver 10 and of the second driver 13. The second driver 13 essentially has the shape of a piston. The rail 11 is designed in the shape of a tube with a round cross section. An outer diameter of the second driver 13 is only slightly smaller than the inner diameter of the tube, so that the second driver 13 can be guided in the cavity 12 of the rail 11 along the longitudinal direction of the rail 11. The first driver 10 has the shape of a ring with a round recess 25 having a diameter which is only slightly larger than an outer diameter of the rail 11. The first driver 10 can therefore be securely guided on the rail 11. The first driver 10 additionally includes a receiver 26 for fastening the holder 4. The rotation axis 9 of the covering device 1 runs though the receiver 26.

A perspective view of the holder 4 of the covering device 1 is represented in FIG. 9. The holder 4 includes connecting means 27, 28 which are configured to engage into the receiver 26 of the first driver for rotatably connecting the holder 4 to the first driver 10.

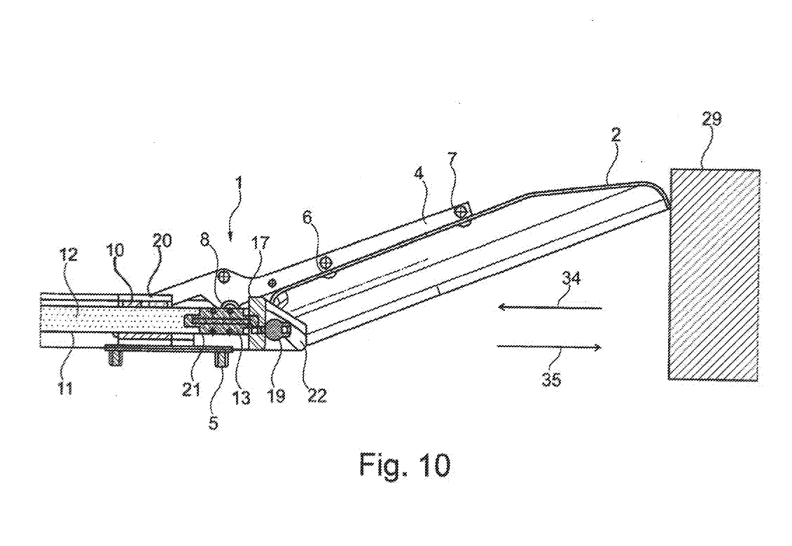

FIG. 10 shows a lateral view of the same covering device 1 and an obstacle 29. The represented covering device 1 in FIG. 10 is located in a partly opened position at a moment after the covering 2 has hit an obstacle 29 during an incomplete closure procedure. The obstacle 29 blocks a further displacing of the first driver 10 in the second direction 35 during a collision between the obstacle 29 and the covering 2. The second driver 13 which is driven by compressed air however, in the cavity 12 of the rail 11 continues to be displaceable after the collision due to the decoupling of the movements of the first driver 10 and the second driver 13. After the collision, the second driver 13 therefore executes a movement in the second direction 35 up to the second stop 17, with which the second driver 13 is in contact in FIG. 10. In the condition of the covering device 1 which is represented in FIG. 10, the cavity 12 continues to be subjected to compressed air, which however exerts no force upon the covering 2 to the right on account of the decoupling of the movements of the first driver 10 and the second driver 13, so that a damage to the covering 2 and to the obstacle 29 is limited.

Apart from a covering device 1, a tool deposition station can also include a receiver for tools. The covering device 1 can be fastened with the fastening means 5 to the receiver of the tool deposition station such that in the covered position of the covering device 1, the covering 2 protects a tool which is located in the receiver of the tool deposition station from dust and dirt. In the opened position of the covering device 1, the tool is accessible from above to an industrial robot and can be taken from this.

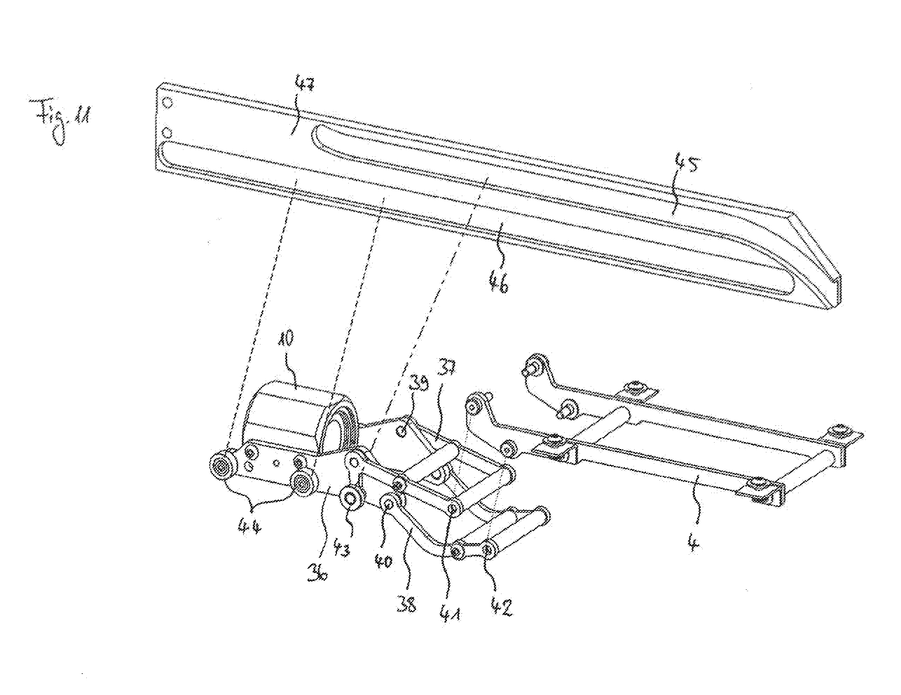

FIG. 11 shows parts of a mechanism for moving the covering 2 according to a further embodiment. This mechanism differs from the mechanism 3 which is described above in that this is configured to effect a purely translatory and non-linear movement of the covering 2. This mechanism includes a holder 4, to which the covering 2 can be fastened, a first driver 10, a connecting element 36 as well as a first connecting piece 37 and a second connecting piece 38. The connecting element 36 is rigidly connected to the first driver 10. The first connecting piece 37 is rotatably connected to the connecting element 36 about a second rotation axis 39 and the second connecting piece 38 is likewise rotatably connected to the connecting element 36 about a fourth rotation axis 40. The first connecting piece 37 is additionally rotatably connected to the holder 4 about a third rotation axis 41 and the second connecting piece 38 rotatably connected to the holder 4 via a fifth rotation axis 42. The holder 4 is represented distanced to the first and second connecting pieces 37, 38 in the manner of an exploded drawing, for an improved overview. The rotation axes 39, 40, 41, 42 are orientated parallel to one another and are distanced to one another in pairs.

The first connecting piece 37 includes a third guide element 43 which is designed as a roller pair, wherein one roller of this roller pair is arranged at a side of the mechanism which is away from the viewer in the representation of FIG. 11 and is not therefore visible in the drawing. The connecting element 36 additionally includes a fifth guide element 44 which is designed as two pairs of two adjacent rollers. One of these pairs is arranged at the side of the mechanism which is away from the viewer in the representation and is not therefore visible in the representation. This non-visible pair in its embodiment corresponds to the visible pair.

The mechanism moreover includes a fourth guide element 45 and a sixth guide element 46 which are each designed as grooves in a vertical side plate 47. A further side plate with corresponding guide elements is typically additionally provided, but this is not represented in FIG. 11. The third guide element 43 is designed for engagement in the fourth guide element 45 and the fifth guide element 44 for engagement into the sixth guide element 46, which is indicated in FIG. 11 by dashed lines.

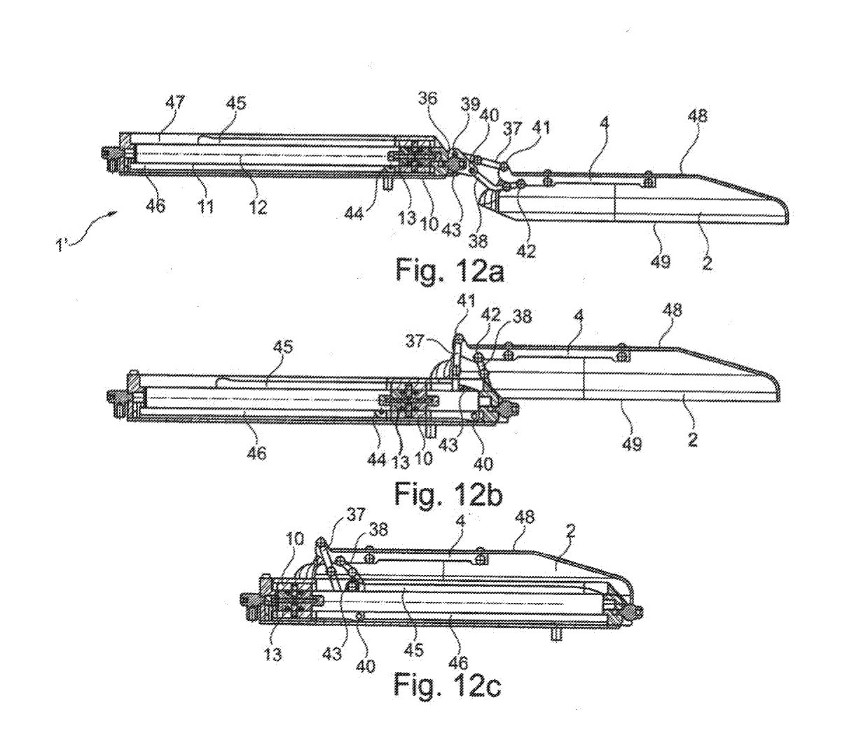

A covering device 1′ with the mechanism which is described with reference to FIG. 11 and which is for moving the covering 2 is represented in FIGS. 12(a)-(c) at different points in time during the opening of the covering device 1′. The covering device 1′ corresponds to the covering device 1 which is described above, with the exception of the differences which are described in the context of FIG. 11. In FIG. 12(a), the covering device 1 is located in a covered position, in which an upper side 48 and a lower side 49 of the covering are orientated horizontally. In the covered position, the covering device 1 is suitable for covering a tool by way of the covering 2.

FIG. 12(b) shows the covering device 1′ during the opening at a point in time after the first driver 10 and the second driver 13 have been displaced to the left. The third guide element 43 is guided by the fourth guide element 45 and the fifth guide element 44 is guided by the sixth guide element 46, during the displacing of the first driver 10. The covering 2 has been lifted on displacing the driver 10 by way of the guidance of the third guide element 43 by the fourth guide element 45. However, the covering 2 here does not undergo a rotation movement, so that the upper side 48 and the lower side 49 of the covering 2 continue to be orientated horizontally.

The covering device 1′ is represented in a completely opened position in FIG. 12(c). In this position, the covering 2 is located in a higher position than in the covered position, The covering in the opened position 2 of the covering device 1′ is located sufficiently far to the left so that a tool which is possibly received in a receiver of the tool deposition station which is arranged to the right of the covering device 1′ and is not represented is accessible from above. The covering 2 undergoes no rotation movement during the complete opening procedure, so that the upper side of the covering 2 and the lower side 49 of the covering 2 continue to be orientated horizontally.

1-17. (canceled)

18. A covering device for a tool deposition station, the covering device comprising:
a covering; and
a mechanism for moving the covering, the mechanism including:
a rail; and
a first driver guided by the rail, the first driver displaceable along the rail and connected to the covering, wherein the covering device can be brought into an opened position by way of a displacing of the first driver along the rail in a first direction, and the covering device can be brought into a covered position by way of a displacing the first driver along the rail in a second direction which is opposite to the first direction, the mechanism configured such that the displacing of the first driver effects at least a partial translatory movement of the covering.

19. A covering device according to claim 18, further including a first guide element rigidly connected to the covering, wherein the covering is rotatably connected to the first driver about a rotation axis which is spaced from the first guide element, and the mechanism for moving the covering further includes a second guide element in engagement with the first guide element, the first and the second guide element configured such that covering is rotatable about the rotation axis by way of the displacing of the first driver.

20. A covering device according to claim 19, wherein the second guide element is a groove.

21. A covering device according to claim 19, wherein the first guide element is a lug.

22. A covering device according to claim 18, wherein the first guide element includes a roller.

23. A covering device according to claim 18, wherein the mechanism further includes:
a first connecting piece and a second connecting piece, wherein the first connecting piece is rotatably connected to the first driver about a second rotation axis and rotatably connected to the covering about a third rotation axis, and the second connecting piece is rotatably connected to the first driver about a fourth rotation axis and rotatably connected to the covering about a fifth rotation axis, the first connecting piece including a third guide element which is spaced from the second rotation axis; and
a fourth guide element in engagement with the third guide element, wherein the mechanism is configured such that the displacing of the first driver effects an essentially purely translatory and non-linear movement of the covering.

24. A covering device according to claim 23, wherein the second rotation axis, the third rotation axis, the fourth rotation axis, and the fifth rotation axis are orientated essentially parallel to one another.

25. A covering device according to claim 23, wherein the third guide element includes at least one roller.

26. A covering device according to claim 23, wherein the displacing of the first driver effects a movement, with regard to which the covering comes to lie lower in the covered position of the covering device than in the opened position.

27. A covering device according to claim 23, further including:
a fifth guide element which is rigidly connected to the first driver; and
a sixth guide element in engagement with the fifth guide element, wherein the fifth guide element is linearly guidable by the sixth guide element given a movement of the first driver.

28. A covering device according to claim 18, wherein the rail includes a cavity which extends along a longitudinal direction of the rail; and the covering device further includes a second driver which is guided in the cavity and is displaceable along the longitudinal direction of the rail, wherein the first driver and the second driver are coupled or can be coupled in a manner such that the first driver is displaceable by way of the displacing of the second driver.

29. A covering device according to claim 28, wherein the rail includes at least one compressed air connection for subjecting the cavity to an overpressure or to a vacuum, wherein the second driver is displaceable within the cavity by way of subjecting the cavity to an overpressure or to a vacuum.

30. A covering device according to claim 28, wherein the first driver and the second driver are configured such that the first driver and the second driver are coupled or can be coupled via a magnetic force.

31. A covering device according to claim 28, wherein the first driver and the second driver are configured such that the first driver and the second driver can be decoupled by way of a force action upon the first driver or upon the covering.

32. A covering device according to claim 28, wherein the rail is in the shape of a tube with a round cross section and the second driver is in the shape of a cylinder which is guided in the tube.

33. A covering device according to claim 28, further including at least one sensor which is configured to detect at least one position of the first driver relative to the rail.

34. A tool deposition station including at least one receiver for receiving a tool, and at least one covering device according to claim 18.
